(19) United States
(12) Patent Application Publication
(10) Pub. No.: US 2003/0016242 A1
(43) Pub. Date: Jan. 23, 2003

(54) Use of hyperlinks in an automation application program and a station for programming such an application

(75) Inventors: Eric Ramahefarivony, Meylan (FR); Bernard Chapas, Varces (FR); Philippe Lemoine, Le Rouret (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Schneider Automation, Valbonne (FR)

(21) Appl. No.: 10/196,169

(22) Filed: Jul. 17, 2002

(30) Foreign Application Priority Data
Jul. 19, 2001 (FR) 01 09 698

(51) Int. Cl. G09G 5/00

(52) U.S. Cl. 345/738

(57) ABSTRACT

The invention discloses a process for use of automation equipment. The automation equipment comprises an application memory in which an application program is stored that is used for the monitoring/control of an automation application. The process comprises a step for the storage of at least one address in the application memory in the form of a hyperlink associated with a document related to the automation application and memorised outside the automation equipment. This address is inserted in a comments field in the application program. The invention also discloses a programming station capable of inserting and displaying such a document.

This invention relates to a process for the use of hyperlinks in an application program memorised in automation equipment used for the monitoring/control of an automation application, a programming station capable of implementing such a process and automation equipment memorising hyperlinks. This automation application may for example be used for industrial process automation, building automation or monitoring/control of electrical distribution networks.

Automation equipment as referred to herein denotes a programmable logic controller, an monitoring/control station, numerical control or any automation module that may contain and execute an application program in order to do the monitoring/control for part of an automation application, particularly such as a variable speed drive or a logical module. In this description, a programming station denotes computer equipment, and particularly a PC type personal computer that can be connected to automation equipment.

An automation equipment is composed of a central processing unit (CPU) and at least one inputs-outputs module forming the link between the central processing unit and the sensors and preactuators of the automation application to be controlled.

Normally, the central processing unit comprises at least one processor, a non-volatile memory usually non-modifiable (ROM) or that may be modified (EEPROM) containing the manufacturer's program also called a proprietary operating system, written in a language specific to the manufacturer of the automation equipment, RAM memory, and an inputs/outputs manager that communicate with each other. The RAM or volatile memory contains the user's program in a first area and data, and particularly images of the states of input-output modules and constants related to the user's program, in a second area.

The user program, called an application program in the rest of this presentation, carries out the monitoring and/or control of an automation application or part of an automation application by means of inputs/outputs controlled by this application program. The designer creates this program (from what we have previously delivered) and it is written in one or several graphic automation languages, particularly including Ladder Diagrams referred to in the following as the LADDER language, Sequential Function Charts (also called Grafcet language) hereinafter referred to as the SFC language, Function Block Descriptions, hereinafter called the FBD language, or for automation text languages such as IL (Instruction List) or ST (Structured Text). These automation languages are preferably conform with standard IEC1131-3 to facilitate programming by an automation designer not necessarily familiar with computer languages. Programs using these automation languages are usually designed on programming stations that may or may not be connected to the automation equipment to be programmed.

In prior art, for example in document WO98/50834, it is known how to create hyperlinks in current application documents on computers, for example PC type computers. These hyperlinks consist of cross references to external documents belonging to other applications. In some cases, the addresses corresponding to these hyperlinks are memorised on the computer hard disk and contain cross references to documents also stored on the hard disk. In other cases, the addresses are stored on the hard disk and contain cross references to external documents memorised on a file server or WEB server in the case of WEB documents.

When a user would like to obtain information about his automation application, for example to create a diagnostic following a deficiency in the automation equipment, the automation equipment is connected to a programming station so that the application program can be displayed on the programming station to determine the deficiency and correct the automation application program. When a diagnostic is being produced, the operator may need to display documents external to the application program on his screen. These documents may be of any type. They may be applications (suffix “.exe”). However, large documents, and particularly documents containing CAD electrical diagrams, images, sound, video or databases, etc., can only be stored in large memories. Therefore, they cannot be stored directly on a memory of the automation equipment, since it would be too small. Admittedly, it would be possible to store these external documents on the programming station of the automation equipment or on an external server connected to the station, such as a file server or a WEB server, but this has a disadvantage. When the programming station fails or when it is replaced by another programming station, the documents are no longer accessible and, even worse no trace of them is kept. In particular, WEB documents stored on a WEB server and that are therefore not stored directly on the programming station are no longer easily accessible because their address on the replacement station will not necessarily be the same.

The purpose of the invention is to overcome this disadvantage by proposing a means of always keeping a trace of useful external documents when an application program is displayed on a programming station, regardless of the location at which these documents are memorised, knowing that the size of these external documents prevents them from being memorised directly in the automation equipment. According to the invention, these documents will always remain easily accessible, so that the automation equipment can be made independent of the programming station. Furthermore, according to the invention, it will also be possible to display documents from any networked terminal using the automation equipment, provided that standard browsing software is installed on it.

This purpose is achieved by a process for the use of automation equipment composed of central processing unit and at least one inputs-outputs module forming the link between the sensors and preactuators of an automation application to be controlled, the central processing unit comprising at least one processor, a non-volatile memory containing an operating system, an application memory that contains an application program used for monitoring/control of an automation application and acting on module inputs-outputs. The process comprises a step for the storage of at least one address in the application memory in the form of a hyperlink associated with a document related to the automation application, memorised external to the automation equipment. According to one feature, the addresses stored in the application memory of the automation equipment are accessible in the form of a hyperlinks in comment fields of the application program.

According to one special feature, the process comprises a step for the display of a document related to the automation application and associated with a hyperlink memorised in the application memory of the automation equipment, using display means loaded on a programming station connected to the automation equipment and using data in a comments field in the application program.

These comments are stored in the application memory of the automation equipment which is small and it is impossible to input anything in these comments other than text. Therefore the creation of hyperlinks in these comments is a means of making a cross reference to all types of external documents, for example video, sound, images, databases, because they are stored in the storage means of the programming station or on an Internet or Intranet WEB server, and not in a memory of the automation equipment.

According to another special feature, the hyperlink manipulated by the programming station is text in the HTML format.

According to another special feature, the application program memorised in the automation equipment is described using an XML language.

According to another special feature, the display means on the programming station show the tree structure of the application program of the automation equipment, at least one address memorised in the application memory of the automation equipment associated with an external document being made accessible in the form of a hyperlink that can be displayed at a given level in the tree structure.

Another purpose of the invention is to propose a computer system for the creation of hyperlinks and to display related documents.

This purpose is achieved by using a programming station capable of implementing such a process for the use of hyperlinks. It comprises means of connection with automation equipment, means of reading an address in the form of a hyperlink, this address being stored in an application memory of the automation equipment, means of searching for and displaying a document associated with the hyperlink, memorised outside the automation equipment and related to the automation application.

According to one special feature, the programming station comprises storage means for at least one document associated with a hyperlink and related to the automation application, insertion means for inserting an address in the form of a hyperlink in a comment field in an application program on automation equipment, this address being stored in the application memory of the automation equipment, means of selecting one or several terms in a comment field of the application program, the insertion means inserting an address in the form of a hyperlink in the comment field at the selected term(s).

The programming station also comprises means of displaying the tree structure of an application program on automation equipment comprising several levels, and insertion means in order to insert an address in the form of a hyperlink at a given level in the tree structure.

According to another special feature, the programming station memorizes at least one “source” file of a description grammar of automation applications in a single hierarchised and object oriented language towards at least one graphic description language (LADDER, SFC, FBD), in an internal memory.

According to another feature, the memory also contains an application program description file, a data description file and an inputs-outputs description file in this hierarchised object-oriented language.

Another purpose of the invention is to propose automation equipment comprising a central processing unit and at least one inputs-outputs module, the central processing unit comprising at least one processor and an application memory that contains an application program that will be used for the monitoring/control of an automation application through the inputs-outputs module(s). The application memory of the automation equipment memorises at least one address in the form of a hyperlink that is accessible in a comments field of the application program and that is associated with a document related to the automation application, this document being memorised external to the automation equipment.

The invention and its features and advantages will be more clearly understood after reading the following description made with reference to the appended drawings in which:

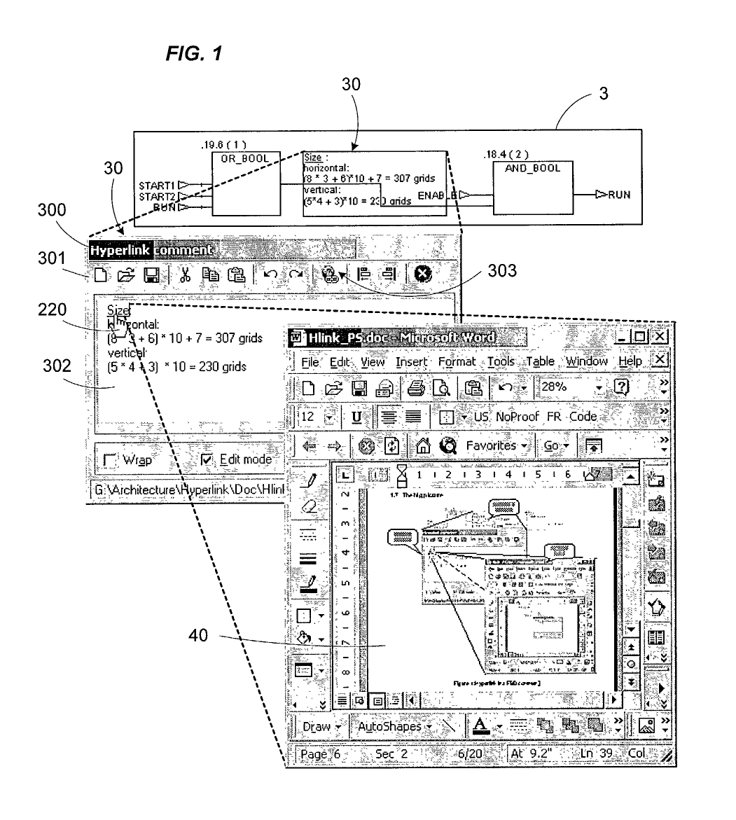

FIG. 1 shows the activation of a hyperlink placed in a comments field of an application program on automation equipment,

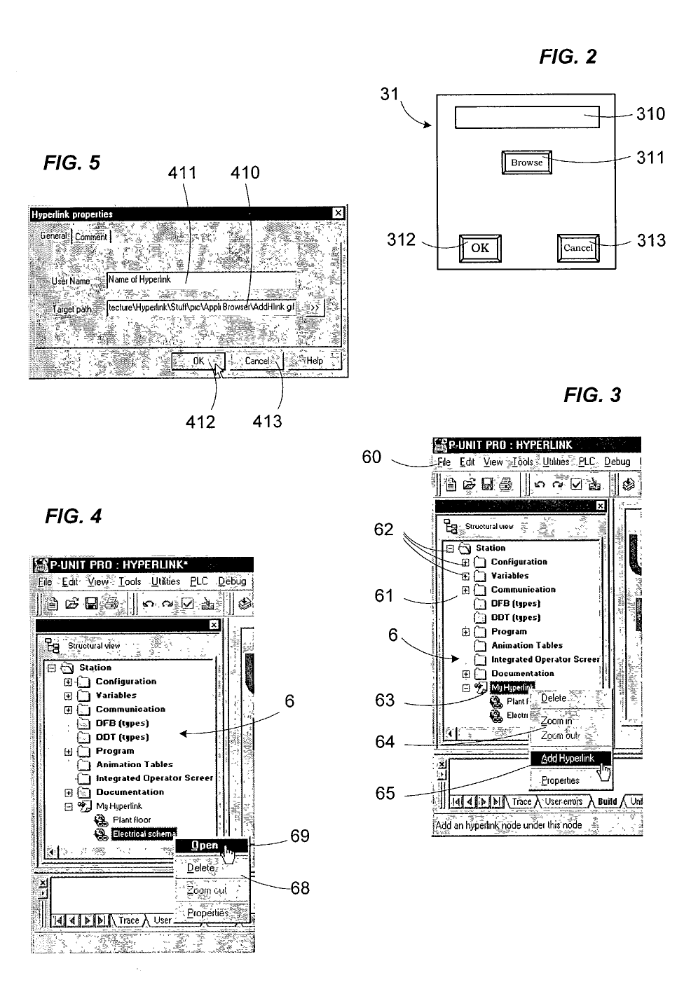

FIG. 2 shows a dialog box for the creation of a hyperlink in the comments field,

FIG. 3 shows the creation of a hyperlink in the tree structure of an application program,

FIG. 4 shows a document being opened from a hyperlink placed in the tree structure of an application program,

FIG. 5 shows a dialog box for the creation of a hyperlink in a tree structure of the application program,

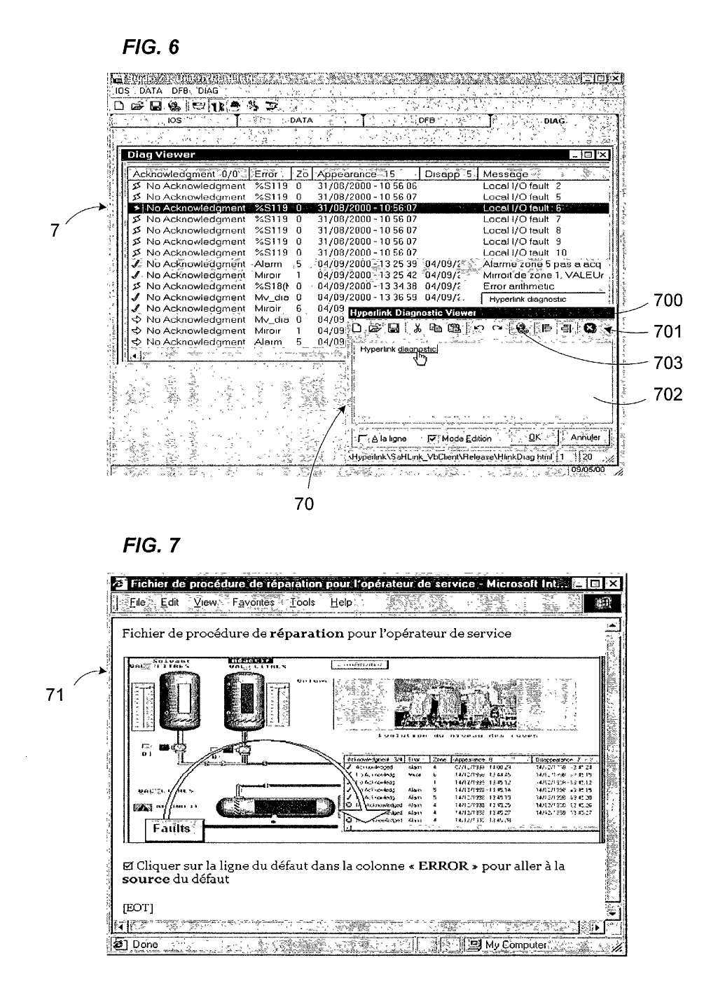

FIG. 6 shows a diagnostic help screen with a diagnostic message using a hyperlink,

FIG. 7 shows an example of an external document associated with a hyperlink related to help with the diagnostic,

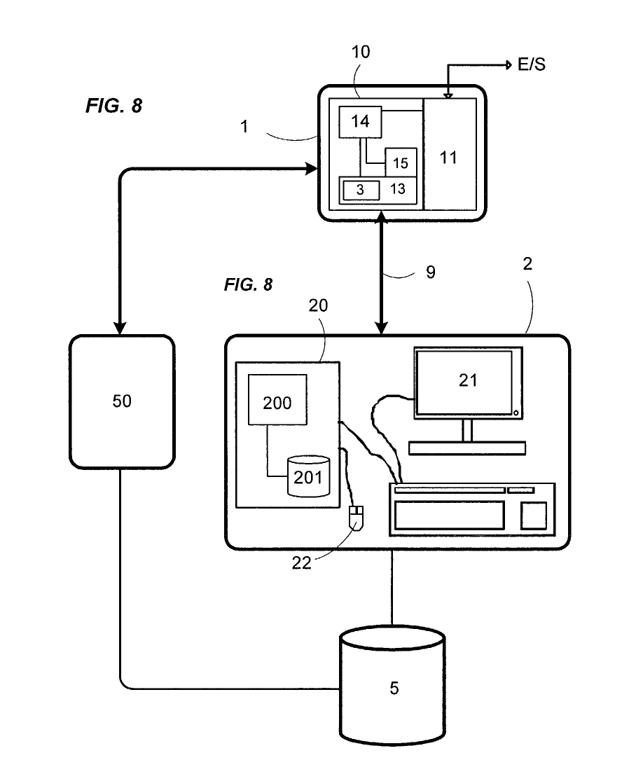

FIG. 8 shows an example architecture of automation equipment and a programming station according to the invention,

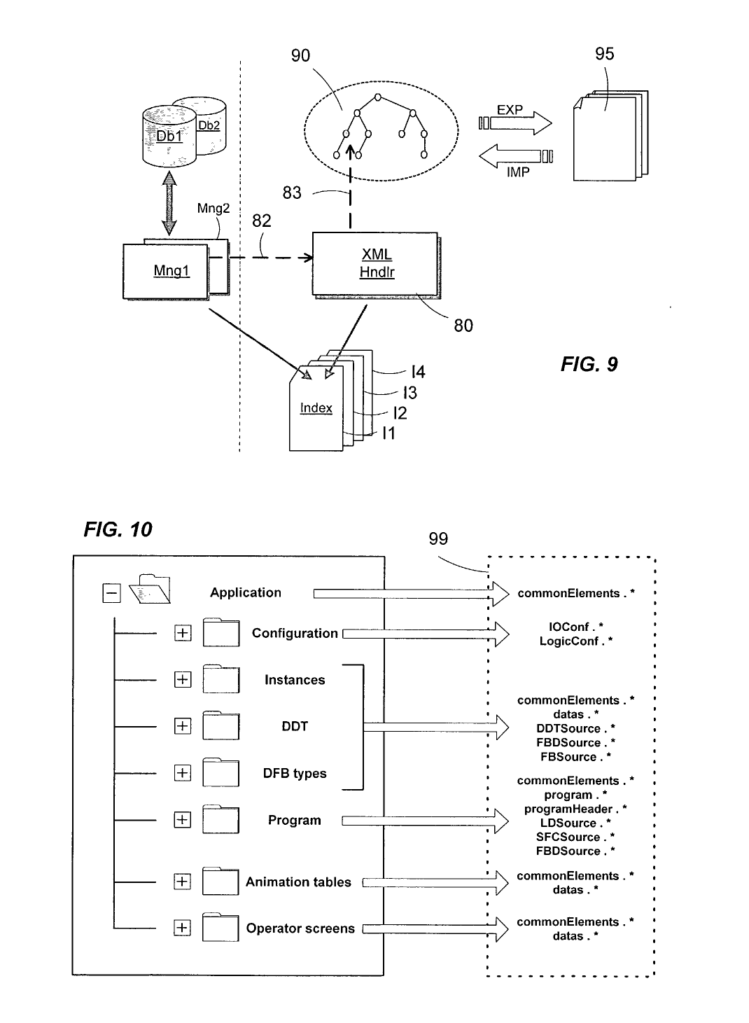

FIG. 9 shows a diagrammatic view of a programming station equipped with an XML handler module to import or export XML language description files from or to one of the automation graphic languages,

FIG. 10 shows a diagrammatic view of the memory organization of the grammar used to describe an application in a single XML language,

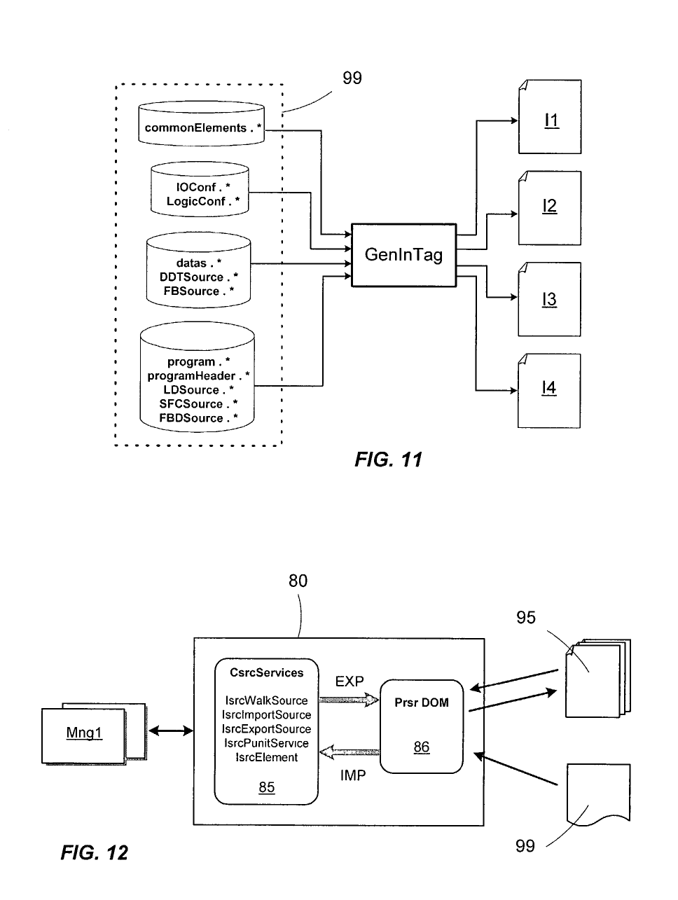

FIG. 11 shows a software component that forms a tag index generator that will be used to produce index files,

FIG. 12 shows a diagrammatic view of the constituent modules of an XML handler module to import and export files from or to one language to another.

The invention will now be described with relation to FIGS. 1 to 12.

Automation equipment (1, FIG. 8) is composed of a central processing unit (10) and at least one inputs-outputs module (11) as mentioned above. The central processing unit comprises a processor (14) and ROM (15), usually non modifiable, containing the manufacturer's program, also called a proprietary operating system, expressed in a language specific to the manufacturer of the automation equipment and storage means in particular containing an application memory (13). The module(s) (11) is (are) connected to sensors and pre-actuators (I/O) of the automation application to be controlled. The user's program, called the application program (3), executes an automation application. In the example in FIG. 1, the application program is written in the LADDER language. This application program (3) is memorised in the application memory (13) of the automation equipment (1). This application memory (13) is usually a RAM memory so the designer of the application program can make modifications to it. But it may also be non-volatile memory (for example PROM) to guarantee integrity of its contents and protect them from any accidental modification.

The application program (3, FIG. 1) is broken down into tasks, a task being a set of instructions executed periodically by the processor of the central processing unit (10). The application program is broken down into modules and has comment fields (30) that are displayed on a screen (21) of a programming station (2) in comments dialog boxes as shown in FIG. 1. These comment fields (30) may be comments about variables or the descriptive sheet of a function block. A comments field (30) is memorised in the application memory (13) of the automation equipment (1), like the application program (3). However, due to the small size of the application memory (13), it is not always possible for the comment fields (30) to contain all information that a user would like to input or display. Furthermore, this comments field (30) can normally only contain text. Therefore, it is impossible, for example, to include installation layout and wiring diagrams, or work notes that were used to develop the program, or images to facilitate debugging, etc. in this comments field (30).

Consequently, according to the invention, the addresses of external documents are stored in the application memory (13) of the automation equipment (1) in which the application program is memorised, being inserted in the form of hyperlinks in the comment fields (30). These hyperlinks are composed of text in an HTML format and are not interpreted when the automation application is executed.

The programming station (2) comprises means of inserting these hyperlinks in the comment fields (30). In the embodiment presented, the hyperlinks are inserted in a comments field (30) from a specific dialog box (31), an example of which is shown in FIG. 2 displayed on the programming station (2). This comments field (30) is filled in using the comments dialog box which consists of a screen window (300, 301, 302, 303, FIG. 1) displayed on the programming station. This window is provided with a header (300) under which there is a toolbar (301) comprising a number of icons which can be clicked on using a pointing device such as a mouse (22) on the programming station (2). There is a space (302) under the toolbar (301) in which the comment can be inserted, and some words of the comment may be in the form of a hyperlink. This hyperlink creation operation is done on the programming station (2, FIG. 8). The term that will become a hyperlink is firstly selected in the comments field (30, FIG. 1) using selection means on the programming station. In the example in FIG. 1, the comments field (30) relates to the size of a variable in the application program (3) and this word “size” can be selected to become the hyperlink, for example using the mouse (22). Then, after a specific icon (303) on the toolbar (301) of the window has been selected, for example using the mouse, the processor (200, FIG. 8) of the central processing unit (20) of the programming station (2) activates the appearance of an inset on the screen (21, FIG. 8) of the programming station (2) containing the Create hyperlink dialog box (31). In another variant, the dialog box (31) could also be activated from a pull down menu with a title such as “insert” and sub-headings, one of which could be “hyperlink”. According to one embodiment, the Create hyperlink dialog box (31) shown in FIG. 2 comprises a field (310) for input of the document path, external to the application program (3) to which the user would like the selected term to include a cross reference. The path is memorised in the form of an address in the application memory (13) of the automation equipment (1). For example, this address stored in the memory (13) of the automation equipment may be in the following form:

<a href=“D:\Architecture\Patent\Pat.doc”>hlink</a>

The tag beginning with the anchor parameter “<a” inserts the absolute or relative path of the resource prefixed by the “href” keyword (in this case, a document with a .doc suffix). The hypertext word or expression that will be underlined in a WEB browser or in the programming station is “hlink” in this case, placed before the “</a>” tag is closed. The slash “/” as a prefix to the anchor parameter “a” indicates that the tag is closed, thus delimiting the extent of the underlined text.

If the user does not know the path of the external document that he wants to associate with the created hyperlink, he can activate a button (311), for example below the address input field (310). With this button (311), the user can use a browser to browse through the documents memorised on the hard disk (201) of the programming station (2) or another medium. The user can then insert the path of the external document to be linked in the input field (310) by carrying out a drag and drop action for this path from the file explorer that is open in a window of the programming station screen (21) at the same time as the Create hyperlink dialog box (31).

Advantageously, external documents associated with hyperlinks according to the invention may be of all types and they may be large since they are memorised in storage means (201) such as the hard disk (201) of the programming station (2) which may for example be a PC type computer, rather than a memory of the automation equipment (1). They may also be memorised on a server (5), for example such as an Internet or Intranet server, if the documents are WEB pages. The address to which the hyperlink refers is then an URL address. The hyperlink then forms a shortcut to all external documents or to WEB sites that are to be associated with the automation application.

Once the address has been input in the dialog box (31), this input can be validated or cancelled by clicking on a button (312, 313) using the mouse. For example a first button (312) is named “OK” for the validation. The other button (313), for example named “CANCEL”, can be used to exit from the Create hyperlink procedure at any time. After validation, the hyperlink term in the comments field (30) appears in a different manner from other comment terms, in a known manner, for example underlined in blue. When the user uses his mouse (22) to move the pointer to the hyperlink term, this pointer changes to the shape of a hand (220) as shown in FIG. 1. This is done to inform the user that this term is a hyperlink, in other words that if he selects this term by clicking on it, the means specific to the programming station will read the address input in the dialog box (31, FIG. 2) and according to the invention this address is stored in the application memory (13) of the automation equipment (1) so that the external document corresponding to this address can be opened later. A help bubble may be displayed after a given time if the user keeps his pointer fixed to the hyperlink. Similarly, the address of the created hyperlink can be displayed when the pointer is kept on the term hyperlink.

The associated documents may be of any type such as text, video, sound, images, databases, etc., and of a very wide variety of natures, particularly such as:

layout drawings for the automation application,

detailed description files for the automation application including flowcharts, sequences, algorithms, operating modes,

mechanical and electrical CAD files,

input/output wire files,

parameter or setting files for a module or a function,

help files for use during development, operations and debugging, knowing that these files may be also be enriched by the operators themselves in order to build up a knowledge base on the application,

etc.

The documents can only be displayed on the programming station (2), and only if the programming station (2) is connected to the automation equipment (1) and if it is provided with means of enabling this display on the screen (21), for example such as a WEB browser or software to access information stored on the hard disk (201) of the programming station (2). In the case shown in FIG. 1, the associated document (40) is displayed on the “Microsoft WORD” software (registered trademark) the name of this document in this case being “Hlink_PS.doc”.

According to the invention, document addresses are all stored in the application memory (13) of the automation equipment (1) so that a trace is always kept. In particular, when the programming station (2) is changed, particularly due to a failure, the addresses of the documents remain memorised on the automation equipment (1) and may always include a cross reference in the form of hyperlinks to external documents stored on a server such as a WEB server. Therefore, the user is not obliged to use a particular programming station (2).

Thus, according to the invention, the designer of an application program may store the different hyperlinks that he considers are relevant with a particular part of this application program, at the same time that he inputs his application program. The fact that he can input and store these hyperlinks at the same time as writing or modifying the application program makes this task easier and much more intuitive for the program designer and/or developer.

Therefore, in order to display a document associated with a hyperlink, data exchanges symbolised by the arrow (9) in FIG. 8 are necessary between the memory (13) of the automation equipment (1) storing the address of the associated document and the programming station (2). The programming station is provided with means of displaying the address in the form of a hyperlink on the screen (21), means of reading the address in the memory (13) of the automation equipment (1) when the user clicks on the hyperlink displayed in the application program (3) and means of displaying the external document associated with the hyperlink. In order to achieve this, the programming station (2) can also use search means so that it is possible to search for the document associated with the hyperlink either on storage means on the programming station (2) such as the hard disk (201) of its central processing unit (20), or outside the programming station (2), for example a server (5) of an internal (Intranet) or external (Internet) network accessible through a local or global communication network, as a function of the address stored in the application memory (13) of the automation equipment (1). Once the associated document has been found, the processor (200) of the programming station (2) executes a specific display program of the browser used to display the associated document on the screen (21).

An application browser loaded on the programming station (2) displays the structure of the application program (3) according to a tree structure (6) as shown in FIG. 3. This browser is divided mainly into two parts, one part (60) forming its menu and another part (61) displaying the tree structure (6). Levels (62) of this tree structure correspond particularly to the different tasks executed by the processor (14) of the central processing unit (10) of the automation equipment (1) and sections forming the tasks. In this tree structure (6), hyperlinks can be created for terms inserted at some levels (62) in the tree structure. Addresses stored in the memory (13) of the automation equipment (1) and input for these created hyperlinks, include cross-references to external documents stored on the programming station (2) or on a server (5) such as a WEB server. For example, a hyperlink with a cross-reference to a document concerning the wiring diagram for a coil would be located in the tree structure in a level below the coil level. The user begins by creating a directory (63) in the tree structure (6), grouping all hyperlinks that he would like to insert in the tree structure (6). This user directory (63) is created in the browser by selected the root of the tree using the mouse, in this case “Station” as shown in FIG. 3. The operator then clicks on the right button of the mouse (22) to display a context sensitive menu. In this context sensitive menu (not shown) the user clicks on an instruction (“Add user directory”) that will be used to add a directory. For example, the user can add the directory (63) called “My hyperlink” as shown in FIGS. 3 and 4. A hyperlink can be created in a sublevel in this directory as follows. The user selects the directory (63) that he has created, in this case “My hyperlink”, using the mouse. The user then does a right click to display a context sensitive menu (64) shown in FIG. 3. In this context sensitive menu (64), the user chooses the option (65) “add hyperlink” shown in FIG. 3. When he clicks on this option, a dialog box is displayed inset on the screen of the programming station (2), in which he can input the address of the hyperlink, similar to the Create dialog box (used to add a hyperlink) in a comments field. This dialog box also includes a field (410, FIG. 5) in which the path of the associated document is input, an input field (411) that the user can use to input the term, for example “electrical scheme” in the example in FIG. 4 that he would like to become a “hyperlink” to this sub-level of the created directory (63). Once the path of the document has been input in the specified field of this dialog box, the user can validate or cancel the operation to insert the hyperlink term in the tree structure (6) by clicking on a button named “OK” (412) or a button named “CANCEL” (413). Once the hyperlink has been created, the user can display the document associated with this hyperlink, the address of which is stored in the memory (13) of the automation equipment (1) by selecting the term hyperlink, for example by doing a right click and choosing the “Open” option (69) in the context sensitive menu (68) that is displayed as shown in FIG. 4.

With reference to FIG. 6, it is also possible to create hyperlinks in messages (70) related to a fault in the application program (3) These messages (hyperlink diagnostic viewer) (70) are similar to the comment fields (30) in the application program (3), and they can only contain small quantities of text due to the small size of memories in the automation equipment. They can be used to display a header (700), a toolbar (701) including an icon (703) to create hyperlinks and an input space (702), when display means are called. These messages (70) are displayed inset on the diagnostic viewer (7) of the application program (3). In a diagnostic viewer why? they say message . . . (70) it will be possible to click on a hyperlink term, for example on the “diagnostic” term as shown in FIG. 6. This action sends the user to documents that may contain additional information that will help him in his search for a solution to the failure or to a page on which he can store data about the failure. Furthermore, since the external documents can easily be modified, this is a means of building up a large knowledge base for the application program. FIG. 7 shows an example in which the associated diagnostic help document (71) is a WEB page displayed on “Microsoft Internet Explorer” (registered trademarks).

It is already known how to modify a comment in line in an application program without disturbing execution of the application program in the automation equipment. Therefore another advantage of the invention is its possibility of making an on line modification to a hyperlink without modifying operation of the automation equipment, which makes it easy for users to update a knowledge base.

It is also possible to browse through different documents if the hyperlink memorised in the automation equipment is pointing to an external document that may itself contain other hyperlinks.

Thus, without considerably increasing the quantity of information memorised by the automation equipment (1), the ergonomy and usage facilities of information available on equipment external to the automation equipment (1) are considerably improved. While hyperlinks are usually reserved for management and viewing of documents by enabling information to be added from a source document by links to complementary documents with an infinite number of nesting levels, the innovation lies in its use in an automation application, in other words complementary documents can equally well be inserted and viewed in real time during the design and during operation of the automation application. Therefore, this will facilitate the work done by maintenance operators, which will lead to a reduction of maintenance times and therefore optimise availability of the automation application.

According to another embodiment of the invention, it will also be possible to display documents related to the automation application from any terminal (50, FIG. 8) connected to the automation equipment (1) on which the addresses of these external documents are stored. This terminal (50) should simply contain browsers, for example such as “Microsoft Internet Explorer” (registered trademarks), viewers or editors to display external documents, for example memorised on a server (5) such as a WEB server. The advantage is that it is possible to click on a hyperlink and display external documents on the terminal (50) without needing to use any graphic language programming and editing software on the automation equipment.

In order to achieve this, it is useful to describe an automation application using a single universal language such as XML (extended Markup Language) based on hierarchised objects starting from a grammar that is suitable for translation of an automation application program written in one of the standard graphic languages, for example LADDER, SFC or FBD, into this XML language. This description is text only (no binary information) and is memorised on the programming station (2) on which the application program (3) is loaded. It is independent of the implementation and must respect XML standards. The XML description of an application may be stored entirely or partly in the form of files. These files may be imported from and/or exported to third party software. Each descriptive object of the application in the XML language is assigned firstly with XML tags that are words surrounded by the “less than” (“<”) and “greater than” (“>”) symbols, and secondly attributes (in the form “name=value”). Therefore, the entire application may be described using this type of tags and attributes. The tags are used only to delimit data elements and the entire interpretation of the data is left to the application that reads them.

According to the invention, the comment and the hyperlink that it may contain form a single text string with tags in the standard HTML format surrounding the hyperlink term in the comment. In the application program formed in the graphic language, the hyperlink is formulated in a standard manner, in other words is surrounded by tags:

“a href=hyperlinkPath>hyperlinkText</a>“

As described above, the start tag “<a href=” defines the address of the associated document “hyperlinkPath”. This path corresponds to a URL (Uniform Resource Location) address.

Due to this standard writing convention, the syntax for formulation of the hyperlink will be rewritten according to a standard transformation when passing from the graphic language or the text language to the XML language. The text string requires processing, particularly for the tags surrounded by the less than “<” and greater than “>” symbols since these delimiters are also used in XML. The process for export to the XML format that is described below will include verification and check functions of the syntax used to write the hyperlink and will translate the less than “<” and greater than “>” symbols into “&lt;” and “&gt;” respectively, meaning “less than” and “greater than”. The hyperlink will be represented as follows in the XML format:

“&lt;a href=hyperlinkPath&gt;hyperlinkText&lt;/a&gt;”

This means of rewriting can be used directly in XML. This type of XML format can be used from a standard browser, for example such as Microsoft Internet Explorer (registered trademarks), particularly to access hyperlinks, through the use of XML Stylesheet Language Transformations (XSLT) according to the XML standard.

The grammar description files (99, FIG. 10) are organised as follows.

An automation application may be broken down mainly into three parts, namely its program, its data and its inputs/outputs. According to the invention, the grammar for each of these parts is written in a document type “.dtd” definition file (Document Type Definition) (for example program.dtd for the application program file, datas.dtd for the data file, IOConf.dtd for the inputs-outputs configuration file) or in an equivalent manner in a “*.xsd” type “Schema” file. In the following we will refer to “.dtd” files, but they can be replaced by “Schema” files with the “.xsd” suffix that is much more powerful than the obsolete “.dtd” files since they are themselves described in XML whereas the “.dtd” files have a specific syntax that cannot be analysed by an XML syntax parser. When the “datas.*” type notation is used, this means that it is a data file that may be of the “.dtd” or “.xsd” type. Each of the parts of an application may itself be broken down into subparts each of which is the subject of a “.dtd” description file. Thus, for example the program file (program.dtd) may include source files (LDsource.dtd, SFCsource.dtd and FBDsource.dtd as shown in FIG. 10) that contain the grammars of different graphic languages such as LADDER diagrams (LD), sequential function charts (SFC) and function block diagrams (FBD).

“.dtd” or “.xsd” grammar files (99, FIG. 10) are files specific to the manufacturer of the automation equipment. They contain the description of the different grammars and define the structure of XML description files. Thus, the “Application” folder (FIG. 10) comprises the (commonElements.*) file that contains common elements for the automation application, namely the application name, the application or version production date, the version number and comments. The “Configuration” folder contains configuration files for inputs/outputs (IOConf.* FIG. 10) and the logical configuration (LogicConf.*), respectively. The “Instances”, “DDT”, “DFB type” folders contain the data descriptions, instances, DDT, FB type in the form of files (datas, DDTSource.*, FBDSource.*, FBSource.*). The “Program” file contains source files (LDsource.*, SFCsource.* and FBDsource.*) that contain a description of each respective grammar for each graphic representation typically for process automation. The “Animation tables” folder contains a description of the animation tables that is composed partly of files (commonElements.* and datas.*). The “Operator screen” folder contains descriptions of operation screens composed of common element files (commonElements.*) and file data (datas.*). These definition files of the document type “.dtd” or the schema type “.xsd” define the structure of XML files. An XML file for an application represents an instance of the grammar defined in the “.dtd” or “.xsd” file corresponding to it. The XML files are specific to the client's automation application. The principle of correspondence between these two types of files is defined by the XML standard V1.0 in accordance with the document object model (DOM). The document object model (DOM) is a set of standard application programming interfaces (API) for manipulating XML files.

The correspondence between XML files and application databases is as follows:

An automation application is stored in binary in a memory of a programming station (2). This automation application according to prior art for graphic representations is shown in FIG. 9 to the left of the chained dotted line, in several databases; one database (Sb1) for the program, one database (Db2) for the inputs-outputs configuration, etc. The description of the application in the XML language is completely independent of its implementation in the manufacturer's databases. In order to achieve this independence, a particular software component (GeninTag) was developed that forms a tag index generator shown in FIG. 11.

The automatic tag index generator software (GeninTag) must be executed to produce index files that will be used to create a correspondence between the XML tree structure representing the automation application and database structures (Db1, Db2). This component extracts the keywords (elements, objects and attributes) from the different “.dtd” grammar files that define the XML grammars for the program, data, inputs-outputs configuration in the XML language, to generate indexes organised according to several folders (I1 to I4, FIG. 11) each containing one or several index constant files used by the different managers (Mng.1 to Mng.n) managing an automation application.

An XML handler (XML Hndlr) (80, FIG. 9) is a software component, for example developed using the C++ language, that can be used through a COM interface. It encapsulates and uses the services of an XML parser component (DOM parser or DOM Prsr) (86, FIG. 12) and offers high level services for management of the XML graphic tree structure (90). The XML handler (XML Hndlr) is a component that the station uses to create the tree structure (90) representative of the automation application starting from description files (95) using grammar files (99) or creating this tree structure from requests made by the application database managers (Mng.1, Mng.n). It uses the different managers (Mng.1, Mng.2) calling the services of the XML handler (XML Hndlr) using index files (I1 to I4) generated by the GeninTag component. As shown in FIG. 9, each part of an application, for example a program (Db1), data (Db2), is managed by a specific manager for management of each data type, for example (Mng. 1) for the application, (Mng. 2) for data, etc. The XML handler (XML Hndlr) comprises an export routine (EXP) and an import routine (IMP), in addition to the parser (DOM Prsr).

Within the framework of this invention, only the export routine is useful. The objective is to be able to make hyperlinks accessible in the source program written in XML. The export routine writes automation application data in one or several XML description files, while the import routine reads the automation application data in one or several XML description files. These routines call a service module (85) (CsrcServices) that is itself broken down into several services. An “IscrWalkSource” service is used for browsing through the XML language file (95) loaded in memory. The “CsrcServices” component also comprises an “IsrcImportSource” service that initializes reading an XML file (95), the “IsrcexportSource” service that writes XML files and the “IsrcUnitService” component that manages services specific to the programming station. Finally, the XML manager (80) comprises an “IsrcElement” service that is a service enabling access to the contents of XML data (elements and attributes). Each of the managers (Mng. 1, Mng. 2) dialogs with the different services of the XML handler (80). They use index files (I1 to I4) generated by the GenInTag component corresponding to the data in the database.

The application memorised in the XML document (95, FIG. 9) is modelled by the XML handler component (80) in the form of a tree structure (90) using firstly information distributed in the memory of the programming station in databases and in the form of binary files, and secondly indexes (I1 to I4) to access this information and represent it in tree structure form. The XML handler component (80), as shown in FIG. 9, communicates through notifications with the managers (Mng. 1, Mng. 2) of the databases (Db1, Db2) and with the module representing the application in memory. Thus, during the export routine, a manager (Mng1, 100) can send a “CreateNode (index, value)” notification (82) requesting the XML handler (80) to create a node with a given index and a given value. The XML handler (80) uses the index values and grammar files (99) to request the tree structure management module to create a node with the tag name equal to the name defined by “tagname”, and value denoted by “value”, using a “Create Node (tagname, value)” notification (83). When these grammars have been developed in the XML language and the files have been written, it will be possible to develop an interpreter on automation equipment, this interpreter module having the function of translating instructions describing an application formulated in the XML language, into instructions that can be executed by the operating system of the automation equipment. This is a means of making automation equipment for which the programming language would be accessible to any editor available on a PC type machine and that an automation application designer could thus use to develop application programs for which the files would be stored in ASCII, regardless of the manufacturer of the automation equipment and the operating system used, provided only that the XML language interpreter is installed on the automation equipment in the proprietary binary language.

It will be obvious to persons with experience in the subject, that this invention could be used with embodiments in many other specific forms without departing from the scope of the invention as claimed. Consequently, these embodiments must be considered simply as illustrations that can be modified within the scope defined by the appended claims, and the invention must not be limited to the details given above.

1. Process for the use of automation equipment (1) composed of a central processing unit (10) and at least one inputs-outputs module (11), the central processing unit (10) comprising at least one processor (14) and an application memory (13) that contains an application program (3) used for monitoring/control of an automation application through the inputs-outputs module(s) (11), characterised in that the process comprises a step for storage in the application memory (13) of at least one address in the form of a hyperlink that is accessible in a comments field (30) of the application program (3) and associated with a document related to the automation application, memorised external to the automation equipment (1).

2. Process according to claim 1, characterised in that the addresses stored in the application memory (13) of the automation equipment (1) are accessible in the form of hyperlinks in the comment fields (30) of the application program (3).

3. Process according to claim 2, characterised in that it comprises a step for the display of a document related to the automation application and associated with a hyperlink memorised in the application memory (13) of the automation equipment (1), using display means loaded on a programming station (2) connected to the automation equipment (1) and using data in a comments field (30) in the application program (3).

4. Process according to claim 3, characterised in that at least one document related to the automation equipment is stored in the storage means (201) of the programming station (2).

5. Process according to claim 3, characterised in that at least one document related to the automation application is stored on an Internet or Intranet WEB server (5).

6. Process according to one of claims 4 or 5, characterised in that the hyperlink manipulated by the programming station (2) is text is the HTML format.

7. Process according to claim 6, characterised in that the application program (3) memorised in the automation equipment (1) is described using an XML language.

8. Process according to claim 3, characterised in that the display means on the programming station (2) show the tree structure (6) of the application program (3) on the automation equipment (1), at least one address memorised in the application memory (13) of the automation equipment (1) associated with an external document being made accessible in the form of a hyperlink that can be displayed at a given level (62) in the tree structure (6).

9. Programming station (2) capable of implementing a process according to one of the previous claims, characterised in that it comprises means of connection with automation equipment (1), means of reading an address in the form of a hyperlink stored in an application memory (13) of the automation equipment (1), means (21) of searching for and displaying a document associated with the hyperlink, memorised external to the automation equipment (1) and related to the automation application.

10. Programming station according to claim 9, characterised in that it comprises means (201) of memorizing at least one document associated with a hyperlink and related to the automation application.

11. Programming station according to claim 9, characterised in that it comprises means of inserting an address in the form of a hyperlink in a comments field (30) in an application program (3) on automation equipment (1), this address being stored in the application memory (13) of the automation equipment (1).

12. Programming station according to claim 11, characterised in that it comprises means of selecting one or several terms in a comments field (30) of the application program, the insertion means inserting an address in the form of a hyperlink in the comments field (30) at the selected term(s).

13. Programming station according to claim 11, characterised in that it comprises means of displaying the tree structure (6) of an application program (3) of automation equipment (1) comprising several levels (62), and insertion means to insert an address in the form of a hyperlink at a given level in the tree structure (6).

14. Automation equipment comprising a central processing unit (10) and at least one inputs-outputs module (11), the central processing unit (10) comprising at least one processor (14) and an application memory (13) that contains an application program (3) that will be used for the monitoring/control of an automation application through the inputs-outputs module(s) (11), characterised in that the application memory (13) of the automation equipment (1) memorizes at least one address in the form of a hyperlink that is accessible in a comments field (30) of the application program (3) and that is associated with a document related to the automation application, this document being memorised external to the automation equipment (1).
